(19) United States
(12) Patent Application Publication
(10) Pub. No.: US 2010/0239880 A1
(43) Pub. Date: Sep. 23, 2010

(54) METAL MATRIX COMPOSITES AND METALLIC COMPOSITE FOAMS WITH IN-SITU GENERATED CARBONACEOUS FIBROUS REINFORCEMENTS

(75) Inventors: Bhaskar Patham, Bangalore (IN); Suresh Sundarraj, Bangalore (IN)

Correspondence Address: General Motors Corporation;c/o REISING ETHINGTON P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/405,666

(22) Filed: Mar. 17, 2009

(51) Int. Cl. B32B 5/02; B32B 15/04; B22F 7/04

(52) U.S. Cl. 428/613; 428/634; 419/9

(57) ABSTRACT

An exemplary embodiment discloses a thermoformed composite powder metallurgy based material including a matrix of sintered metal particles including at least one of a metal and metal alloy; and carbon fibers within said matrix having an orientation and shape derived from a precursor fibrous matte.

### TECHNICAL FIELD

The field to which the disclosure generally relates includes metal composite materials including carbon reinforced metal composite materials, and more specifically to thermoformed metal-matrix composites or metallic composite materials with oriented fiber reinforcement for structural applications.

### BACKGROUND

The property entitlement in carbon fiber reinforcements is achieved in the single walled carbon nanotube, with modulus as high as 1000 GPa. However, such levels of stiffness are not always required in composite structural materials including carbon-fiber reinforced metal-matrix composite structural materials. In addition, applicability of carbon nanotubes for wide ranging engineering applications, especially in the general-use automotive segment, is severely limited by their high cost and limited availability. The relatively high cost of carbon fibers is primarily due to the processing conditions involved, including oxidation of a precursor polymer such as pitch or poly (e.g., acrylonitrile) in an inert environment at very high temperatures.

Metal matrix composite fabrication generally includes the distinct steps of consolidation of metal and the reinforcements, such as carbon fiber, followed by the production of the composite part. In operations involving casting of the molten metal mixed with carbon-fiber reinforcements, it is very difficult to precisely control the directionality of orientation of the fibrous reinforcements.

One advantage offered by powder metal based processing is that the steps involving consolidation of the metal and reinforcements as well as the part forming can be accomplished together. Even in the latter process, directionality is difficult to be maintained.

### SUMMARY OF EXEMPLARY EMBODIMENTS OF THE INVENTION

In an exemplary embodiment, a powder metallurgy based thermoformed composite material is provided, including a matrix of sintered metal particles, including at least one of a metal and metal alloy; and carbon fibers within said matrix having an orientation and shape derived from a precursor fibrous matte.

In another exemplary embodiment, a method of making powder metallurgy based thermoformed composite material is provided, including providing a matrix of metal particles including at least one type of metal particles, said metal particles supported on, and at least partially around, a fibrous matte having a first orientation and shape, said fibrous matte including a plurality of layers of organic polymer containing fibers; and, subjecting said assembly of the metal particles and the fibrous matte to a thermoforming process at a temperature—such that said metal particles sinter, and said fibrous matte at least partially carbonizes to form carbon fibers having a second orientation and shape derived from said first orientation and shape—so as to obtain a metal-matrix composite part.

In another exemplary embodiment, a composite powder metallurgy based precursor material for forming a thermoformed part therefrom is provided including a precursor matrix of metal particles including at least one metal; and a fibrous matte within said matrix, said fibrous matte including a plurality of layers of organic polymer containing fibers, said fibrous matte having a predetermined orientation, said metal particles adhered to said fibrous matte.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIGS. 1A-1D show exemplary steps in forming an exemplary thermoformed composite powder metallurgy based part according to an embodiment.

FIGS. 2A-2D show exemplary steps in forming an exemplary thermoformed composite powder metallurgy based precursor assembly for forming a thermoformed part therefrom according to an embodiment.

FIG. 3 shows an exemplary process flow according to embodiments shown in FIGS. 2A-2D.

FIGS. 4A-4C show exemplary steps in thermoforming an exemplary composite powder metallurgy based part according to an embodiment.

FIG. 5 shows an exemplary process flow according to embodiments shown in FIGS. 4A-4C.

### DETAILED DESCRIPTION OF EXEMPLARY EMBODIMENTS

The following description of the embodiment(s) is merely exemplary (illustrative) in nature and is in no way intended to limit the invention, its application, or uses.

In an exemplary embodiment, a composite preform assembly composed of fibrous matte and powdered metal may be formed by assembling one or more metal powders on a substrate including one or more organic polymer containing (carbon fiber precursor) fibrous matte layers. The composite preform assembly may then be subjected to thermoforming at temperatures sufficient to sinter the metal powder e.g., above the melting point of the metal powder. The composite preform assembly may be thermoformed by conventional processes including simultaneously applying mechanical pressure and heat (e.g., hotpressing) to the composite preform assembly—sintering the metal particles, as well as forming carbon fibers from the fibrous matte layers—while shaping into a metal-matrix composite part. The thermoformed composite part thereby includes a carbon fiber reinforced metal part where the carbon fibers may have a predetermined preferred orientation (directionality), for example substantially the same as or derived from the fibrous matte layers.

In some embodiments, the thermoformed composite metal part may have a thickness from about 0.5 mm to about 500 mm. In other embodiments, the thermoformed composite metal part may be a structural metal part, for example as a part of a conventional internal combustion engine, electric, and hybrid automobile.

In some embodiments, the thermoforming process may include subjecting said composite preform assembly to simultaneously applied mechanical pressure and heating at a temperature above a melting point of at least some of the metal powders such that metal particle sintering takes place and at least a portion of the fibrous matte carbonizes to form carbon fiber portions.

It will be appreciated that conventional thermoforming or hotpressing processes may be used including where the heat may be applied through a die or other tool that applied mechanical pressure and/or heating may be applied by external sources such as by a conventional convective and/or irradiative heating furnace, and/or electromagnetic energy heating sources.

In one embodiment, during heating at thermoforming temperatures and/or during the thermoforming process, the metal powder in the composite preform assembly may melt and consolidate (sintering process) around the fibrous matte as well as optional additional organic and/or inorganic filler materials and/or reinforcement material, while fibers in the fibrous matte carbonize to form carbon fibers having substantially the same directionality (orientation) as the fibrous matte. Thus, carbon fibers may be formed in-situ where the energy for carbonization of these precursors is provided by the energy derived from melting the metal and/or metal alloy powder.

In some embodiments, it will be appreciated that the carbon fibers may include continuous and/or discontinuous carbon fibers as the carbonization of the carbon fiber precursor material together with a thermoforming process may or may not result in discontinuity of the resulting carbon fibers. In some embodiments, it will be appreciated that the thermoforming process may impart a different shape to the composite preform assembly, and that therefore some of the resulting carbon fibers may have an orientation that is not the same as the fibrous matte layers, but is derived therefrom to form a second preferred orientation.

In another embodiment, the substrate fibrous matte containing carbon fiber precursor may be subjected to an annealing process at a first temperature below the melting temperature of the metal to oxidize and/or stabilize the carbon fiber precursors in the substrate fibrous matte within the composite preform assembly (with powder metal and optional filler and/or reinforcement material) prior to a thermoforming process. For example, the oxidation/stabilization annealing may take place below a degradation (carbonization) temperature of the carbon fiber precursors in the substrate fibrous matte prior to heating to a thermoforming temperature.

In one embodiment, the metal and/or metal alloy powder may have a melting point above 300° C. (to facilitate carbonization of carbon fiber precursors), preferably from about 300° C. to about 950° C., more preferably from about 400-700° C. In other embodiments, the composite preform assembly may be subjected to thermoforming just above the melting point of the metal powder, for example from about 1 degree to about 150 degrees Centigrade above the melting point of the metal powder.

In some embodiments, the metal and/or metal alloy powder may include any metal or combination of powdered metals, that may be subjected to conventional powder metallurgy processes—to form metal containing parts—including thermoforming or hotpressing. In one embodiment, the metal and/or metal alloy powder includes aluminum. In another embodiment, the metal and/or metal alloy powder includes magnesium.

In other embodiments, the metal and/or metal alloy powder may have a variety of particle sizes, depending on the metal powder and the desired thermoforming (sintering) temperature and sintering rate. In some embodiments, the metal powder may have a primary and/or agglomerated particle size ranging from about 20 nm to about 100 microns as measured by conventional processes including transmission electron microscopy (TEM) and/or gas adsorption.

It will be appreciated that the process of heating the composite preform assembly to an oxidation/stabilization temperature and subsequently to a thermoforming temperature may be accomplished as ramped increases of temperature with annealing at selected intermediate constant temperatures or may be accomplished as a continuous temperature ramp (increase). As stated earlier, the thermoforming process may include any combination of heat sources applied prior to and/or during application of mechanical pressure to the composite preform assembly, to a temperature above a melting point of at least one of the metal powders to induce metal particle sintering.

In one embodiment, the composite preform assembly (lay-up) may include powdered metal in addition to optional material such as additional fibers and/or carbon fiber precursors and/or particulate material which may serve to provide additional reinforcement in a thermoformed part. For example, in some embodiment, the additional fibers or particulate materials may be any organic or inorganic material to include inorganic carbides, metals, metal oxides, and/or pre-formed carbon fibers.

The composite preform assembly (lay-up) may also include additional optional functional materials such as organic and/or inorganic filler material as well as adhesion forming (glue) material, such as an elastomeric adhesive. The additional optional material may have a major size (e.g., diameter, length) ranging from the order of nanometers (nano) to the order of microns (micro). It will be appreciated that the additional reinforcement material may be formed of individual fibers and/or particulate material and/or agglomerates of individual fibers and/or particulate material.

In another embodiment, the fibrous matte substrate may have a random fiber arrangement, such as a random weave, or be arranged with a predetermined fiber directionality (orientation), such as having a cross-ply weave etc. (weave orientation).

In another embodiment, the fibrous matte includes micro- or nano-sized (e.g., fiber diameter) carbon fiber precursor material which may be cellulosic (cellulose containing material), such as rayon and/or other organic polymer material subject to carbonization at thermoforming temperatures. In another embodiment, the fibrous matte including carbon fiber precursor material may include pitch fibers or poly-acrylonitrile (PAN) fibers. In other embodiment, the organic filler material and/or additional reinforcement material may include the carbon fiber precursor material mentioned above.

In another embodiment, the composite preform assembly is subjected to thermoforming in the presence of a vacuum. In some embodiments the vacuum may range from less than atmospheric pressure (<760 Torr) to vacuums on the order of 10⁻⁹ Torr, more preferably from about 10⁻¹ Torr to about 10⁻⁵ Torr. In some embodiments, the oxidation/stabilization and/or thermoforming steps may take place in an oxidizing atmosphere e.g., in the presence of oxygen containing gases. In other embodiments, the thermoforming steps may take place in an inert gas containing atmosphere. In other embodiments, the thermoforming steps may take place in a substantially non-oxidizing atmosphere.

In another embodiment, heating the composite preform assembly at thermoforming temperatures may lead to gaseous by-products (e.g., carbon containing gases or hydrogen containing gases) which may be at least partially removed (e.g., pumped out under vacuum). For example, the gaseous by-products may emanate from one or more of the fibrous matte (e.g., carbonization of the fibrous matte), the optional additional reinforcement material, and/or the optional filler material. In another embodiment, the gaseous by-products may be allowed to at least partially remain within the metal (e.g., by control of the thermoforming process such as temperature and/or ambient pressure and/or application of mechanical pressure) to create a foamed metal microstructure that may have a cellular and/or porous structure (e.g., interconnecting and/or isolated cells) to form a thermoformed part including a shaped or unshaped film or sheet structure.

It will be appreciated that the optimal parameters including temperature and pressure of the thermoforming process to obtain an optimally sintered (and optionally foamed) microstructure may depend on a variety of factors including the type and particle sizes of the metal and/or metal alloy, the type of carbon fiber precursor material, the amount and rate of gaseous by-product given off, thermoforming process parameters such as the heating source, the type of die and level of mechanical pressure applied to the die.

In one embodiment, the powdered metal including optional additional material, such as reinforcement particles/fibers and/or adhesion material, such as elastomeric adhesive to improve adhesion to the fibrous matte, may be separately contacted onto the fibrous matte, or may be mixed together with the powdered metal prior to being contacted onto the fibrous matte.

In some embodiments, the powdered metal including optional additional material may be contacted onto the fibrous matte by brushing and/or spraying the powdered metal and/or the optional additional material onto the fibrous matte.

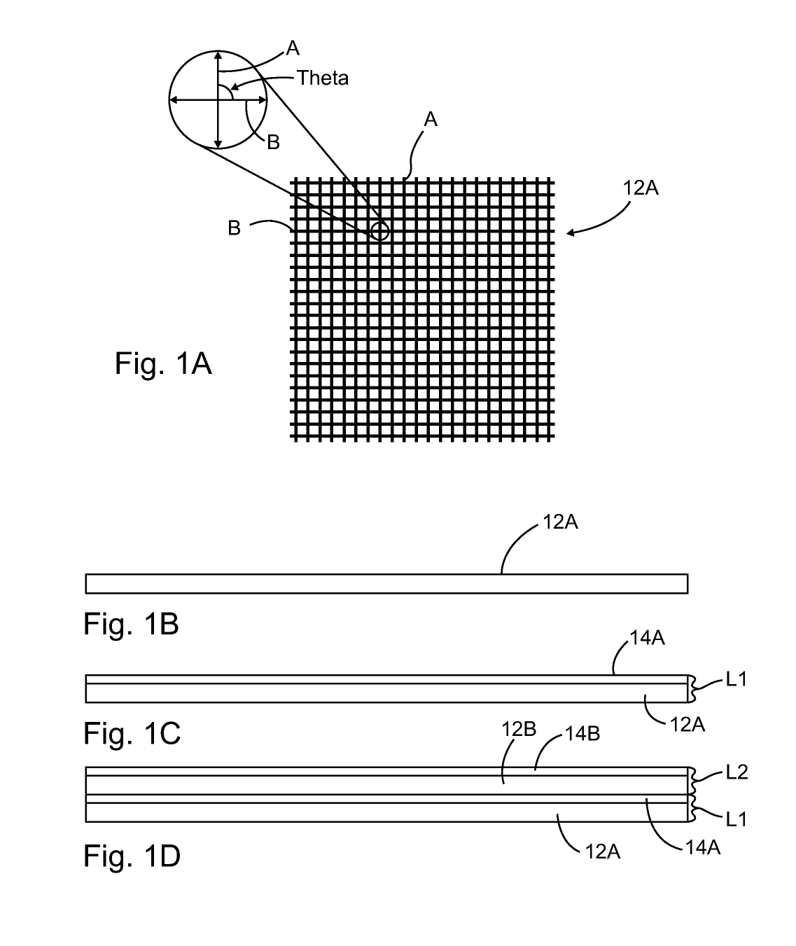

For example, in an exemplary process, referring to FIG. 1A (top view and magnified view) and 1B (side view), a fibrous matte substrate 12A is provided. For example, as shown, in one embodiment, the fibrous matter 12A may include a weave pattern including two major lengthwise fiber orientations (e.g., A and B) where an angle (e.g., theta) between the two major lengthwise may be up to about 90 degrees. In other embodiments the angle between the two major lengthwise may be from about 10 to about 90 degrees. Referring to FIG. 1C, one or more powdered metals 14A including optional additional reinforcement material and fillers according to embodiments, is contacted on the fibrous matte substrate 12A to form a composite matte layer L1. The composite matte layer may then be heated to a temperature where stabilization and/or oxidation may take place. The stabilization and/or oxidation may be below a degradation temperature of the fibrous matte as well as below the melting point of the one or more powdered metals.

Referring to FIG. 1D, another stabilized and/or oxidized fibrous matte substrate 12B and powdered metals 14B forming a composite matte layer L2 similar to composite fibrous matte layer L1 may be formed on composite fibrous matte layer L1. The process may be repeated to form a multi-layered composite preform assembly to subsequently form a metal-matrix composite part having a desired thickness. In other embodiments, the respective layers may be first formed, stacked and then heated to a stabilization temperature where oxidation of fibrous mattes may optionally take place. For example, in some embodiments, the number of layers may be from about 1 to about 1000 to form a desired precursor material thickness to subsequently form a desired metal-matrix composite part thickness.

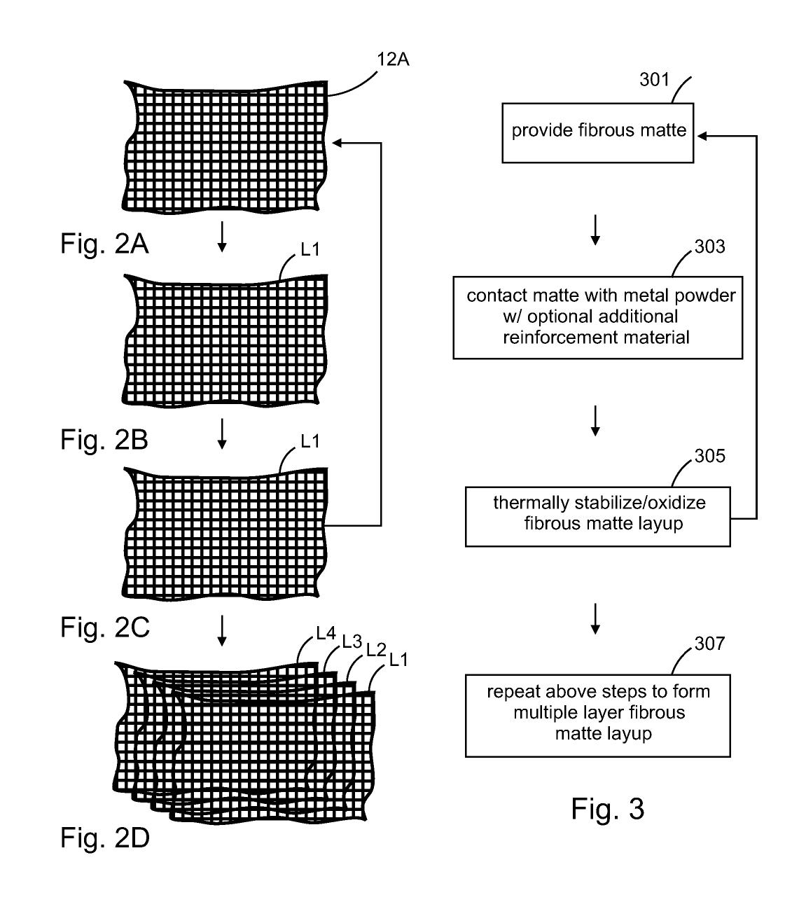

Referring to FIGS. 2A-2D in conjunction with process steps in FIG. 3, is shown another exemplary embodiment. Referring to FIG. 2A and step 301 a fibrous matte substrate e.g., 12A according to embodiments is provided. Referring to FIG. 2B and step 303, one or more powdered metals including optional additional reinforcement material and fillers according to embodiments, is contacted on the fibrous matte substrate e.g., 12A to form a composite matte layer L1. Referring to FIG. 2C and step 305, the composite matte layer L1 may then be heated to a stabilization and/or oxidation temperature below the melting point of the one or more powdered metals. Referring to FIG. 2D and step 307, steps 301-305 (FIGS. 2A-2C) may be repeated to form a multi-layered composite preform assembly (e.g., stacked composite matte layers L1, L2, L3, L4).

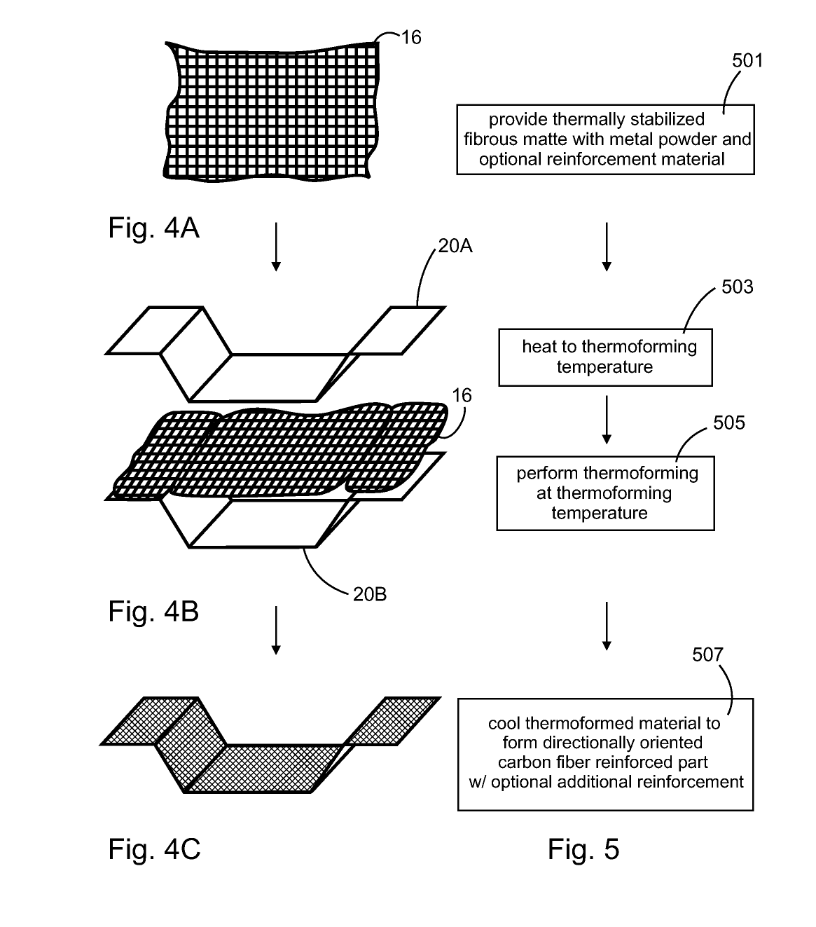

Referring to FIGS. 4A-4C in conjunction with FIG. 5 are shown process steps according to exemplary embodiments. Referring to FIG. 4A and step 501, one or more composite matte layers or a composite preform assembly (lay-up) e.g., 16 is provided e.g., following the process outlined in FIG. 3. In step 503, the composite preform assembly 16 may then heated to a thermoforming temperature (prior to or during thermoforming) above the melting point of powdered metal in the composite preform assembly e.g. 16 according to embodiments. Referring to FIG. 4B and step 505, the composite preform assembly e.g., may then be subjected to a thermoforming process by applying mechanical pressure to the composite preform assembly 16 e.g., through shape forming die e.g., 20A, 20B to shape the composite preform assembly e.g., 16 into a metal-matrix composite part e.g., 18 including carbon fibers having a predetermined directional orientation derived from the matte fiber orientation. For example, at least a portion of the metal-matrix composite part may have a carbon fiber orientation substantially the same as the matte fiber orientation.

It will be appreciated that the carbon fibers may be fully or partially formed prior to applying die pressure or during application of die pressure. Referring to FIG. 4C and step 507, the thermoformed metal matrix composite part (e.g., automobile part) may then be cooled either before or following release of die pressure to form a directionally oriented carbon fiber reinforced metal-matrix composite part. In addition, as noted above according to embodiments, the metal matrix composite part may be a foamed metal part formed by capture of evolved gases from the carbonization and/or thermoforming process to include an isolated and/or interconnected cellular microstructure.

In some embodiments, following the thermoforming process, portions of the metal matrix composite part that are in sheet form, e.g., substantially without curvature, may have an orientation of the carbon fibers (with respect to one another) substantially the same as the precursor fibrous matte. In some embodiments, while the shape of the metal-matrix composite part may change, the overall pattern and shape of the weave in the precursor fibrous matte (fiber orientation and shape with respect to one another) may be retained in the composite metal part. In some embodiments, the orientation or pattern of the carbon fibers derived from the weave pattern of the precursor fibrous matte may be substantially the same as the precursor fibrous matte except for discontinuities in the carbon fibers that may be caused by the carbonization process. In other embodiments, the weave pattern (orientation of fibers with respect to one another) may be slightly deformed by the thermoforming process (e.g., angle between lengthwise directions of fibers having an initially respective different orientation may be changed e.g., from about 1 degree to about 45 degrees.

In some embodiments a major portion of said carbon fibers in a composite part derived from a weave pattern of a precursor fibrous matte including two major lengthwise orientations may have the carbon fibers oriented from about 10 degrees to about 90 degrees with respect to one another, more preferably from about 45 degrees to about 90 degrees with respect to one another.

Among the various advantages of the embodiments include the ability to form carbon fiber reinforced lightweight metallic composite part with directionally oriented fibers where the carbon fibers are formed in-situ. In addition the metallic composite microstructure can be formed with a cellular microstructure that may be altered based on control of the precursor material, and the temperature, atmosphere and pressure of the thermal forming process, thus resulting in a lighter weight metallic matrix composite without any additional processing steps.

The above description of embodiments of the invention is merely exemplary in nature and, thus, variations thereof are not to be regarded as a departure from the spirit and scope of the invention.

What is claimed is:

1. A thermoformed composite powder metallurgy based material comprising:
a matrix of sintered metal particles comprising at least one of a metal and metal alloy; and
carbon fibers within said matrix having an orientation and shape derived from a precursor fibrous matte.

2. The composite material of claim 1, wherein said matrix of sintered metal particles comprises a cellular microstructure.

3. The composite material of claim 1, wherein at least one of said orientation and shape of the reinforcing carbon fibers over at least a portion of said composite material is substantially the same as said precursor fibrous matte.

4. The composite material of claim 1, wherein said orientation of carbon fibers is derived from a weave pattern comprising said precursor fibrous matte.

5. The composite material of claim 1, wherein said orientation of carbon fibers comprises a major portion of said carbon fibers having lengthwise directions oriented from about 10 degrees to about 90 degrees with respect to one another.

6. The composite material of claim 1, wherein the melting point of said metal and/or metal alloy is greater than about 300° C.

7. The composite material of claim 1, wherein the melting point of said metal and/or metal alloy is less than about 950° C.

8. The composite material of claim 1, wherein the melting point of said metal and/or metal alloy is from about 400° C. to about 700° C.

9. The composite material of claim 1, wherein said metal and/or metal alloy comprises at least one of magnesium and aluminum.

10. The composite material of claim 1, wherein the metal matrix comprises organic or inorganic additive material.

11. The composite material of claim 1, wherein the metal matrix comprises at least one of particulate and fibrous inorganic reinforcement material in addition to said carbon fibers.

12. The composite material of claim 1, wherein the metal matrix comprises an adhesive material.

13. The composite material of claim 1, wherein the thermoformed material comprises an automobile part.

14. A method of forming thermoformed composite powder metallurgy based material comprising:
providing a composite preform assembly (lay-up) of metal particles comprising at least one type of metal particles, said metal particles supported on and at least partially around a fibrous matte having a first orientation and shape, said fibrous matte comprising a plurality of layers of organic polymer containing fibers; and,
subjecting said composite preform assembly (lay-up) to a thermoforming process at a temperature such that said metal particles sinter to form a continuous phase, and said fibrous matte at least partially carbonizes to form carbon fibers having a second orientation and shape derived from said first orientation and shape, —thus resulting in a carbon fiber reinforced metal matrix composite part.

15. The method of claim 14, further comprising the step of heating said composite preform assembly (lay-up) at an intermediate temperature prior to said thermoforming process, said intermediate temperature below a temperature of carbonization of said fibrous matte.

16. The method of claim 14, wherein said step of heating comprises a controlled atmosphere and pressure.

17. The method of claim 14, wherein said thermoforming process comprises a controlled atmosphere and pressure.

18. The method of claim 14, wherein said temperature of said thermoforming process is greater than a melting point of at least one metal comprising said metal matrix.

19. The method of claim 18, wherein said melting point of said at least one metal is greater than about 300° C.

20. A composite powder metallurgy based precursor material for forming a thermoformed part therefrom comprising:
an assembly of matrix metal particles comprising at least one metal; and
a fibrous matte substrate supporting and at least partially surrounded by said matrix metal particles, said fibrous matte substrate comprising a plurality of layers of organic polymer containing fibers, said fibrous matte having a predetermined orientation, said metal particles adhered to said fibrous matte.
